(19) United States
(12) Patent Application Publication
(10) Pub. No.: US 2013/0288696 A1
(43) Pub. Date: Oct. 31, 2013

(54) SERVER APPARATUS, SMALL BASE-STATION APPARATUS, AND INTERFERENCE CONTROL METHOD

(71) Applicants: Masahiko Nanri, Kanagawa (JP); Yasuo Koide, Kanagawa (JP); Jifeng Li, Kanagawa (JP)

(72) Inventors: Masahiko Nanri, Kanagawa (JP); Yasuo Koide, Kanagawa (JP); Jifeng Li, Kanagawa (JP)

(73) Assignee: Panasonic Corporation, Osaka (JP)

(21) Appl. No.: 13/977,397

(22) PCT Filed: Feb. 3, 2012
(86) PCT No.: PCT/JP2012/000730

§ 371 Date: Jun. 28, 2013

(30) Foreign Application Priority Data
Feb. 10, 2011 (JP) 2011-027441

(51) Int. Cl. H04W 72/08

(52) U.S. Cl. CPC H04W 72/082
USPC 455/452.1

(57) ABSTRACT

Provided are a server apparatus and an interference control method, wherein interference between cells is inhibited, and a drop in throughput of the entire network is also inhibited. An ABS configuration determining unit (203) of an OMC (200) is provided with an ABS configuration table that is defined such that the frequency with which downstream transmission is stopped is decreased as the number of HeNBs decreases, and the frequency with which downstream transmission is stopped is increased as the number of HeNBs increases. The ABS configuration determining unit (203) obtains the number of HeNBs within an MeNB area, obtains an ABS configuration corresponding to the obtained number of HeNBs from the ABS configuration table, and determines to apply the configuration to the MeNB.

### TECHNICAL FIELD

The present invention relates to a server apparatus, a small cell base station apparatus, and an interference control method which control downlink transmission of a base station apparatus to thereby control interference between base station apparatuses.

### BACKGROUND ART

In recent years, small cell base station apparatuses called “Pico eNB” or “Home eNB” (hereinafter, these base station apparatuses are collectively called “HeNB”) have been developed for the purpose of eliminating the dead zones of mobile phones or spreading data traffic. HeNBs are deployed for covering only restricted small areas such as homes or offices. Accordingly, HeNBs are less likely to involve congestion caused by traffic concentration and thus can he expected to achieve high throughput as compared with macro base station apparatuses, which have been already deployed (“Macro eNB” (hereinafter, referred to as “MeNB”)). However, it is also known that HeNBs may cause interference with MeNBs. The reason behind this is that the users of HeNBs can easily change the installation locations of HeNBs placed in their homes, and it is thus difficult for telecommunication carriers to manage the operational states of HeNBs, in particular.

FIG. 1 illustrates an example of a case where one HeNB is installed in an MeNB cell, and a mobile station communicating with the MeNB (Macro User Equipment (hereinafter, abbreviated as “MUE”)) is located in the MeNB cell, and another mobile station communicating with the HeNB (Home User Equipment (hereinafter, abbreviated as “HUE”)) is located in the HeNB cell. In this case, if the distance between the MeNB and HeNB is short, the HUE receives not only a downlink signal from the HeNB, which is a desired wave, but also a downlink signal from the MeNB, which is an interference wave, at the same time. In this case, the reception quality of the HUE is degraded, which results in a decrease in throughput. Likewise, when the MUE moves closer to the HeNB cell, the MUE is interfered by the signal from the HeNB, which results in a decrease in throughput.

As a solution to this problem, a method called “Almost Blank Subframe” (ABS) disclosed in Non-Patent Literature (hereinafter, abbreviated as “NPL”) 1 has been discussed, for example. In this method, any one of or both of the MeNB and HeNB stop downlink transmission, periodically, so that the interfered base station (victim) is no longer interfered in a subframe where the interfering base station (aggressor) stops transmission. As a result, the throughput of a UE located in the cell provided by the interfered base station is improved. FIG. 2 illustrates how the MeNB stops downlink transmission every fourth sub frame, for example.

Meanwhile, a situation where HeNBs are spread over a wide area as illustrated in FIG. 3A will he discussed. If UEs are uniformly spread in the MeNB area including the HeNB areas in this situation, a majority of the UEs are connected to HeNBs. In this case, an active increase in the number of ABSs by the MeNB to reduce interference to the HUEs can improve the throughput of the whole radio network.

### CITATION LIST

### Non-Patent Literature

NPL 1
R1-105779 “Way Forward on time-domain extension of Rel 8/9 backhaul-based ICIC” (RAN 1)

### SUMMARY OF INVENTION

### Technical Problem

Let us consider a situation where HeNBs arc not spread as illustrated in FIG. 3B. If UEs are uniformly spread in the MeNB area including the HeNB area in this situation, a majority of the UEs are connected to the MeNB. If the MeNB stops downlink transmission using ABSs in this case, a large number of UEs are affected by the decrease in throughput due to non-transmission in the ABSs. Accordingly, there arises a problem in that the throughput of the whole radio network decreases when viewed from a macro perspective.

It is an object of the present invention to provide a server apparatus, a small cell base station apparatus, and an interference control method, each limiting a decrease in the throughput of a whole network while avoiding inter-cell interference.

### Solution to Problem

A server apparatus according to an aspect of the present invention includes: a counting section configured to manage the number of small cell base station apparatuses each located in a cell of a macro base station apparatus and forming a cell smaller than the cell of the macro base station apparatus; a transmission and non-transmission pattern determining section configured to determine a first transmission and non-transmission pattern for the macro base station apparatus and a second transmission and non-transmission pattern for the small cell base station apparatuses in accordance with the number of small cell base station apparatuses located in the cell of the macro base station apparatus; and a transmission section configured to transmit the determined first transmission and non-transmission pattern to the macro base station apparatus and to transmits the determined second transmission and non-transmission pattern to the small cell base station apparatuses.

A small cell base station apparatus according to an aspect of the present invention includes: a measurement section configured to acquire identification information of a neighboring base station apparatus and measures signal strength from the neighboring base station apparatus corresponding to the acquired identification information; and a transmitting section that transmits the identification information and the signal strength to a server apparatus.

An interference control method according to an aspect of the present invention includes: a counting step of managing the number of small cell base station apparatuses each located in a cell of a macro base station apparatus and forming a cell smaller than the cell of the macro base station apparatus; a transmission and non-transmission pattern determining step of determining a first transmission and non-transmission pattern for the macro base station apparatus and a second transmission and non-transmission pattern for the small cell base station apparatuses in accordance with the number of small cell base station apparatuses located in the cell of the macro base station apparatus; and a transmission step of transmitting the determined first transmission and non-transmission pattern to the macro base station apparatus and transmitting the determined second transmission and non-transmission pattern to the small cell base station apparatuses.

### Advantageous Effects of Invention

According to the present invention, it is possible to limit a decrease in the throughput of a whole network while avoiding inter-cell interference.

### BRIEF DESCRIPTION OF DRAWINGS

FIG. 1 is a schematic diagram illustrating how an HUE in an MeNB cell is interfered;

FIG. 2 is a schematic diagram illustrating MeNB and HeNB transmission patterns;

FIG. 3A is a schematic diagram illustrating a case where HeNBs are spread in an MeNB area;

FIG. 3B is a schematic diagram illustrating a case where HeNBs are not spread in an MeNB area;

FIG. 4 is a schematic diagram illustrating a system configuration according to Embodiment 1 of the present invention;

FIG. 5 is a diagram illustrating an ABS management table of an OMC in Embodiment 1 of the present invention;

FIG. 6 is an ABS configuration table;

FIG. 7 is a block diagram illustrating a configuration of an HeNB according to Embodiment 1 of the present invention;

FIG. 8 is a block diagram illustrating a configuration of the OMC according to Embodiment 1 of the present invention;

FIG. 9 is a block diagram illustrating a configuration of an MeNB according to Embodiment 1 of the present invention;

FIG. 10 is a flowchart illustrating an RSRQ measurement procedure in an RSRQ measurement section the HeNB illustrated in FIG. 7;

FIG. 11 is a flowchart illustrating a processing procedure of the OMC illustrated in FIG. 8;

FIG. 12 is a diagram illustrating an updated ABS management table;

FIG. 13 is a flowchart illustrating a processing procedure of the MeNB illustrated in FIG. 9;

FIG. 14 is a block diagram illustrating a configuration of an HeNB according to Embodiment 2 of the present invention;

FIG. 15 is a block diagram illustrating a configuration of an OMC according to Embodiment 2 of the present invention; and

FIG. 16 is a flowchart illustrating a processing procedure of an OMC according to Embodiment 3 of the present invention.

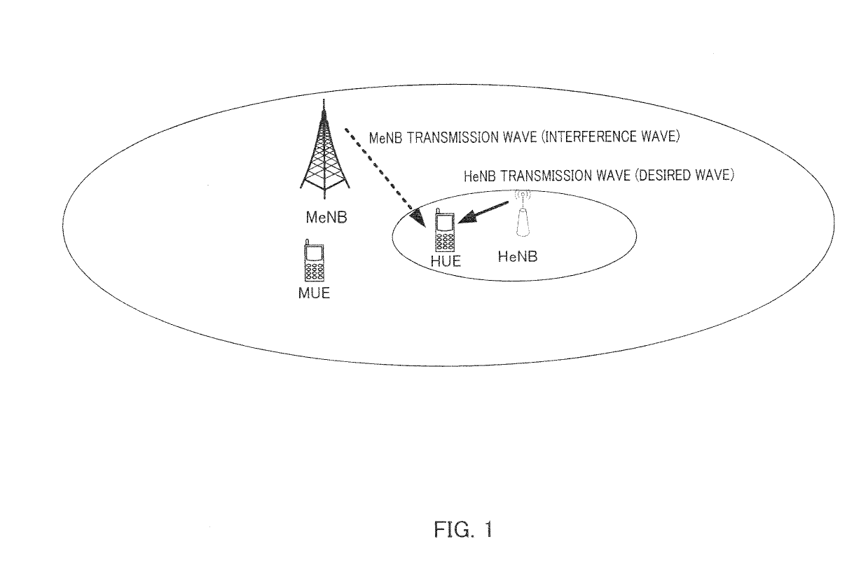

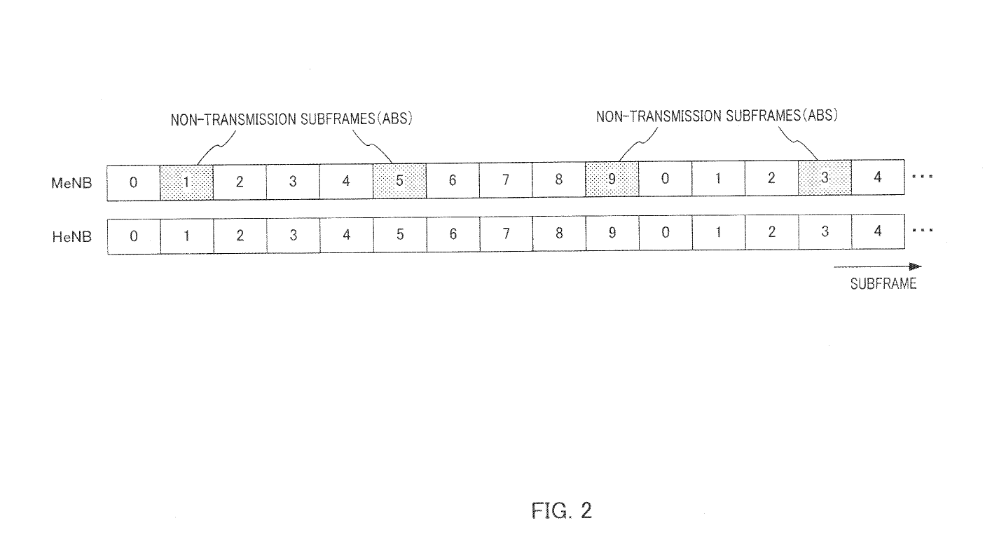

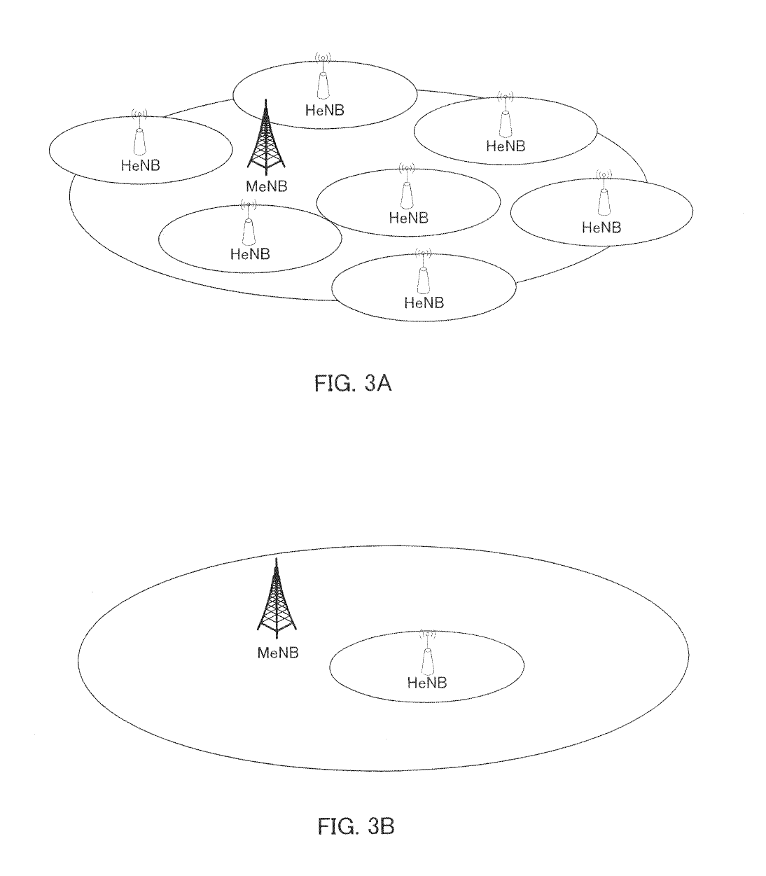

### DESCRIPTION OF EMBODIMENTS

Hereinafter, embodiments of the present invention will be described in detail with reference to the accompanying drawings. Throughout the embodiments, the elements having the same functions are assigned the same reference numerals, and any duplicate description of the elements is omitted.

### Embodiment 1

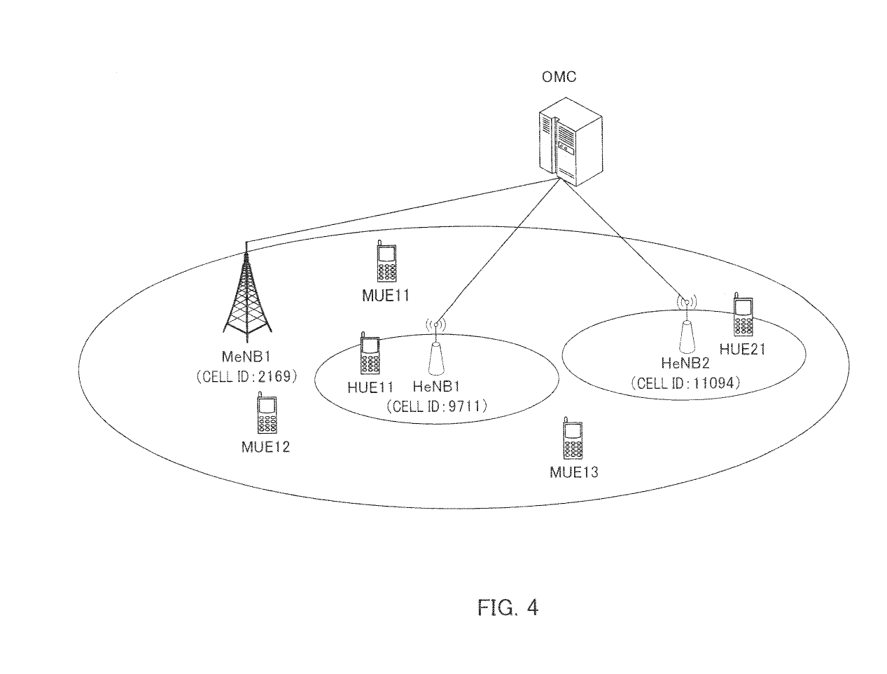

FIG. 4 illustrates a system configuration according to Embodiment 1 of the present invention. In this embodiment, an assumption is made that a total of two HeNBs including HeNB 1 (cell ID=9711) and HeNB 2 (cell ID=11094) is installed in MeNB 1 (cell ID=2169), and also that HeNB 1 is in operation and HeNB 2 is not in operation (in power-off state). The term “cell ID” herein refers to a number assigned to a specific base station. Note that, throughout the description of embodiments, an MeNB and an HeNB are simply and collectively referred to as “base station” unless a distinction needs to be particularly made therebetween.

Moreover, it is assumed that MUEs 11 to 13 are located in the cell of MeNB 1 while HUE 11 is located in the cell of HeNB 1 and HUE 21 is located in the cell of HeNB 2.

In addition, an operation and maintenance center (OMC) is connected to each of MeNB 1, HeNB 1, and HeNB 2, as well as MeNB 2 and MeNB 3 (not illustrated), for example. The OMC manages these MeNBs and determines and indicates an ABS configuration for each of the MeNBs. Note that, the term “ABS configuration” refers to an ABS pattern assigned to an MeNB, i.e., the number that indicates a combination of transmission and non-transmission subframes.

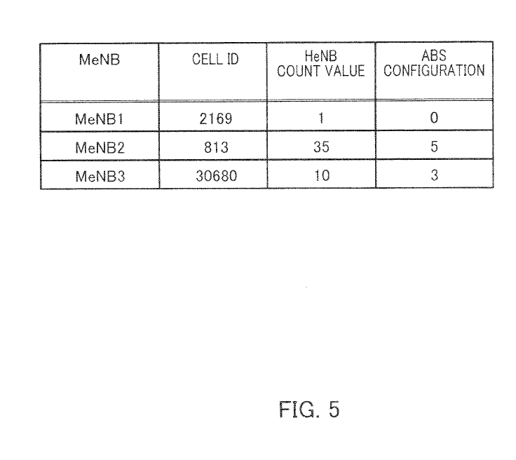

FIG. 5 illustrates an ABS management table of the OMC in Embodiment 1. The term “HeNB count value” herein refers to a value obtained by counting the number of HeNBs operating in the area of the MeNB. In the example in FIG. 4, HeNB 1 is the only one HeNB operating in the cell of MeNB 1 (cell ID=2169). Accordingly, the HeNB count value is 1. Likewise, the OMC manages the number of HeNBs and ABS configuration in the area of each of the MeNBs (not-illustrated) (MeNB 2 (cell ID=813) and MeNB 3 (cell ID=30680)).

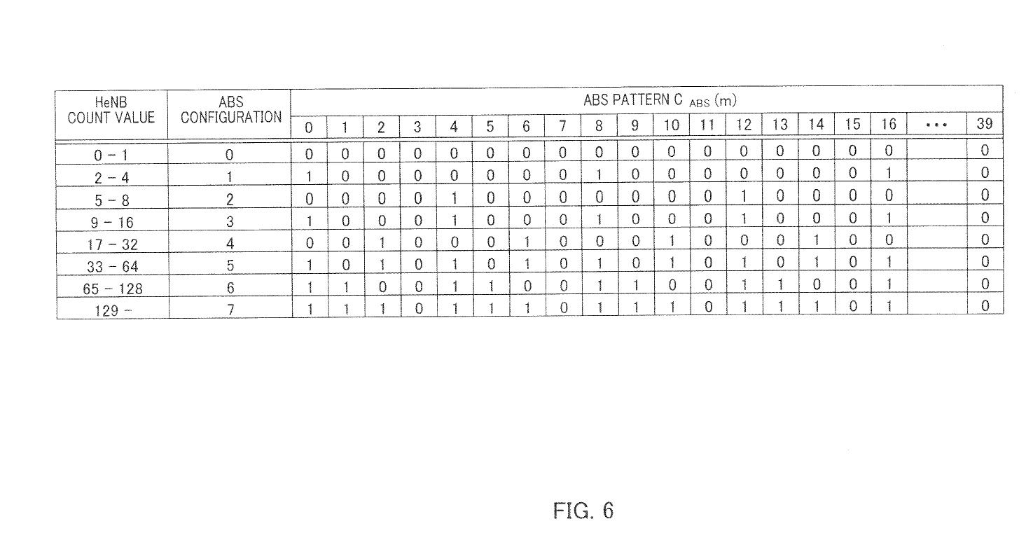

FIG. 6 illustrates an ABS configuration table. This table shows the association between the HeNB count values illustrated in FIG. 5, ABS configurations, and ABS patterns C_{ABS}(m) (m=0, 1, . . . , 39). In this table, m represents a count value that increases every subframe. ABS pattern C_{ABS}(m) defines downlink transmission or non-transmission for 40 subframes, and 0 represents “transmission” and 1 represents “non-transmission.”

In FIG. 6, for example, ABS configuration=0 indicates transmission of all subframes, while ABS configuration=1 indicates that downlink transmission is stopped every eighth subframe. In addition, the ABS configuration table is defined in such a way that the frequency of stopping downlink transmission is reduced as the number of HeNBs becomes smaller while the frequency of stopping downlink transmission is increased as the number of HeNBs becomes larger.

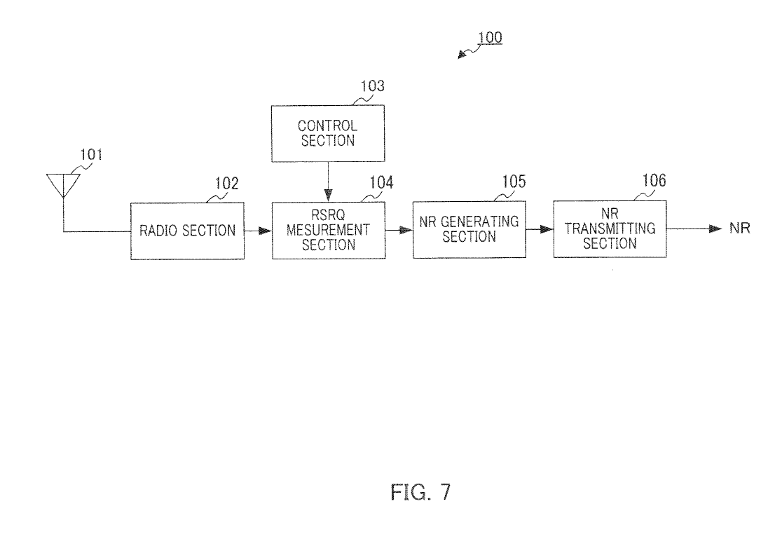

FIG. 7 is a block diagram illustrating a configuration of HeNB 100 according to Embodiment 1 of the present invention. Hereinafter, the configuration of HeNB 100 will be described with reference to FIG. 7.

When HeNB 100 is turned on, radio section 102 receives a downlink radio signal from a neighboring MeNB via antenna 101, then performs predetermined radio processing on the received downlink radio signal and outputs the processed signal to RSRQ measurement section 104.

When HeNB 100 is turned on, control section 103 instructs RSRQ measurement section 104 to measure a reference signal received quality (RSRQ). RSRQ measurement section 104 blindly detects the cell ID of the neighboring MeNB from the downlink radio signal outputted from radio section 102 and measures the RSRQ for each detected MeNB in accordance with the instruction from control section 103. The measured RSRQs are outputted to NR generating section 105.

NR generating section 105 detects an MeNB corresponding to the highest measured RSRQ among the RSRQs outputted from RSRQ measurement section 104, then generates information indicating the detected MeNB (e.g., cell ID), as neighbor relation (NR) information and outputs the generated NR information to NR transmitting section 106.

NR transmitting section 106 transmits the NR information outputted from N R generating section 105 to the OMC.

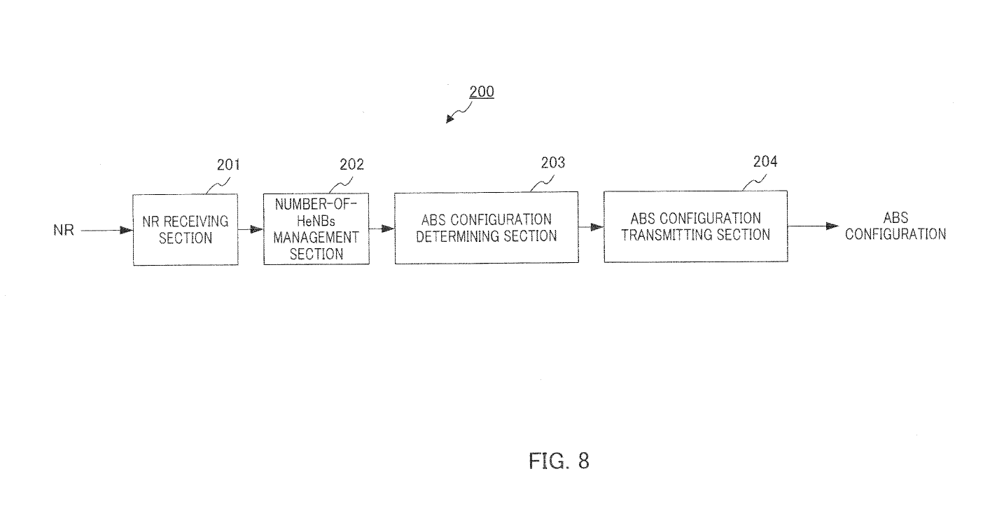

FIG. 8 is a block diagram illustrating a configuration of OMC 200 according to Embodiment 1 of the present invention. Hereinafter, the configuration of OMC 200 will be described with reference to FIG. 8.

NR receiving section 201 receives the NR information transmitted from HeNB 100 and outputs the received NR information to number-of-HeNBs management section 202. Number-of-HeNBs management section 202 assumes that HeNB 100 that has transmitted the NR information is installed in the cell of the MeNB indicated by the NR information outputted from NR receiving section 201, then updates the HeNB count value in the ABS management table illustrated in FIG. 5, and outputs the updated HeNB count value to ABS configuration determining section 203.

ABS configuration determining section 203 includes an ABS configuration table illustrated in FIG. 6, acquires an ABS configuration in accordance with the HeNB count value outputted from number-of-HeNBs management section 202 to determine the ABS configuration for the MeNB. The determined ABS configuration is outputted to ABS configuration transmitting section 204.

ABS configuration transmitting section 204 transmits the ABS configuration outputted from ABS configuration determining section 203 to the MeNB.

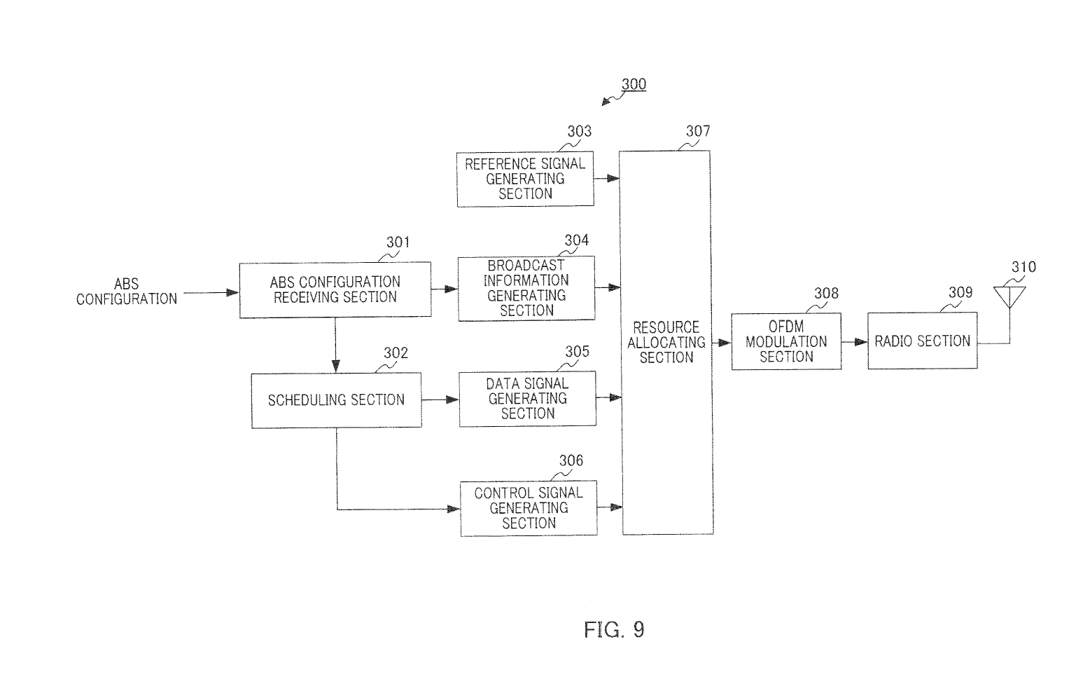

FIG. 9 is a block diagram illustrating a configuration of MeNB 300 according to Embodiment 1 of the present invention. Hereinafter, the configuration of MeNB 300 will be described with reference to FIG. 9.

ABS configuration receiving section 301 includes the ABS configuration table illustrated in FIG. 6, receives the ABS configuration transmitted from OMC 200 and updates the ABS pattern C_{ABS}(m) on the basis of the received ABS configuration. The updated ABS pattern is outputted to scheduling section 302, and the ABS configuration is outputted to broadcast information generating section 304.

Scheduling section 302 determines whether or not a data signal and a control signal are transmittable in each subframe on the basis of the ABS pattern C_{ABS}(m) outputted from ABS configuration receiving section 301. When the signals are transmittable (C_{ABS}(m)=0), scheduling section 302 determines the data payload, modulation scheme and resource allocation for the transmission data and outputs the determined information to data signal generating section 305. In addition, scheduling section 302 determines the control information payload and resource allocation for the transmission control signal and outputs the determined information to control signal generating section 306. Meanwhile, when the signals are not transmittable (C_{ABS}(m)=1), scheduling section 302 outputs nothing.

Reference signal generating section 303 generates a downlink reference signal (RS), a primary synchronization signal (PSS) and a secondary synchronization signal (SSS) and outputs the signals to resource allocating section 307.

Broadcast information generating section 304 generates broadcast information on the basis of the ABS configuration outputted from ABS configuration receiving section 301 and other information (such as a channel bandwidth and system frame number) indicated by a control section (not-illustrated). Broadcast information generating section 304 performs primary modulation on the generated broadcast information and outputs the processed broadcast information to resource allocating section 307.

Data signal generating section 305 generates a data signal on the basis of the data payload, modulation scheme and resource allocation for the transmission data outputted from scheduling section 302 and outputs the generated data signal to resource allocating section 307.

Control signal generating section 306 generates a control signal on the basis of the control information payload and resource allocation for the transmission control signal outputted from scheduling section 302 and outputs the generated control signal to resource allocating section 307.

Resource allocating section 307 allocates resources to time-frequency resources, the downlink reference signal, the primary and secondary synchronization signals outputted from reference signal generating section 303, the broadcast information outputted from broadcast information generating section 304, the data signal outputted from data signal generating section 305, and the control signal outputted from control information generating section 306. Resource allocating section 307 then outputs the resultant signal to OFDM modulation section 308.

OFDM modulation section 308 performs an inverse discrete Fourier transform on the signal outputted from resource allocating section 307 and adds a cyclic prefix (CP), which is a redundancy part, to the signal and outputs the processed signal to radio section 309.

Radio section 309 transforms the signal outputted from OFDM modulation section 308 into a high frequency signal and transmits the signal to an MUE via antenna 310.

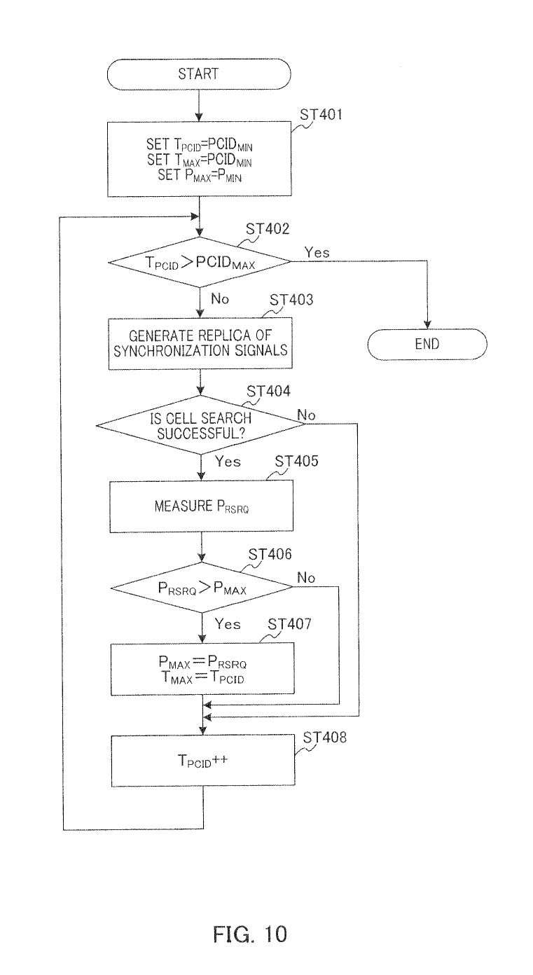

Next, a description will be provided with reference to FIG. 10 regarding an RSRQ measurement procedure in RSRQ measurement section 104 of HeNB 100 illustrated in FIG. 7. In FIG. 10, the smallest cell ID (PCID_{MIN}) within a range of cell IDs (PCID_{MIN} to PCID_{MAX}) which is set as a blind detection target is set as the measurement target cell ID (T_{PCID}). In addition, the cell ID (T_{MAX}) of the maximum RSRQ and the maximum RSRQ buffer (P_{MAX}) are set as PCID_{MIN} and the minimum RSRQ (P_{MIN}) measureable by an HeNB, respectively (ST 401). In this embodiment, the following values are set, for example: PCID_{MIN}=0, PCID_{MAX}=65535 and P_{MIN}=−100 (dBm).

Next, RSRQ measurement section 104 checks whether or not T_{PCID} has exceeded PCID_{MAX} (ST 402) and generates replicas of the synchronization signals based on T_{PCID} (ST 403) if T_{PCID} has not exceeded PCID_{MAX}. There are two types of synchronization signals, which are the primary synchronization signal (PSS) and the secondary synchronization signal (SSS). If T_{PCID} has exceeded PCID_{MAX}, the RSRQ measurement procedure is terminated.

Next, RSRQ measurement section 104 performs cell search using the generated PSS and SSS (ST 404). Specifically, a correlation operation between the received signal and PSS and between the received signal and SSS is performed. If the correlation value is equal to or greater than a certain threshold, the procedure proceeds to ST 405 as a result of successful cell search, i.e., the base station of this cell ID is determined to be located around HeNB 100. If the correlation value is less than the threshold, the procedure proceeds to ST 408 as a result of determining that the base station of this cell ID is not located around HeNB 100.

If the cell search is successful, RSRQ measurement section 104 monitors a downlink reference signal from the base station and measures an RSRQ (P_{RSRQ}) (ST 405). The measured P_{RSRQ} is compared with P_{MAX} (ST 406), and if P_{RSRQ} is greater than P_{MAX}, each of P_{MAX} and T_{MAX} is updated (ST 407). If P_{RSRQ} does not exceed P_{MAX}, the procedure proceeds to ST 408.

Lastly, the measurement target cell ID is incremented (ST 408), and the procedure returns to ST 402. The processing described so far is repeated until T_{PCID} becomes equal to PCID_{MAX}.

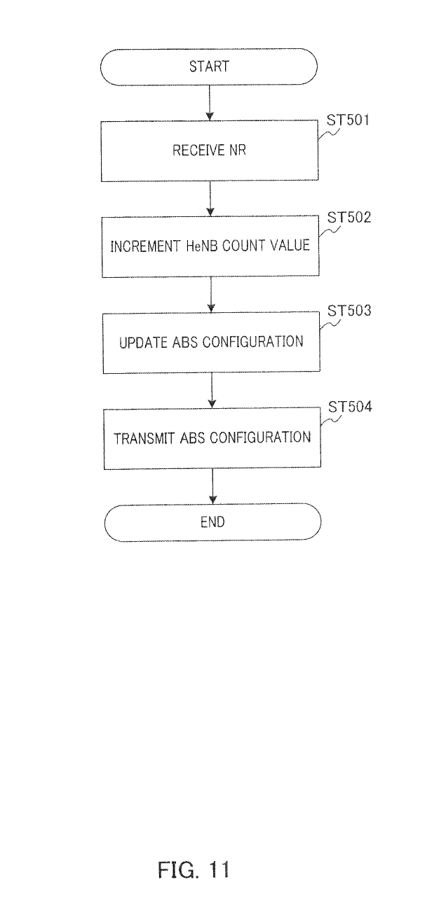

Next, the processing procedure of OMC 200 illustrated in FIG. 8 will be described with reference to FIG. 11. In FIG. 11, NR receiving section 201 receives NR reported from HeNB 100 (ST 501). Subsequently, number-of-HeNBs management section 202 assumes that HeNB 100 is installed in the area of the MeNB indicated by the NR and thus increments the HeNB count value of the MeNB in the ABS management table illustrated in FIG. 5 (ST 502). In the example illustrated in FIG. 4, 2169 is reported to OMC 200 from HeNB 2 as the NR, so that OMC 200 increments the HeNB count value of MeNB 1 by one in the ABS management table illustrated in FIG. 5. The HeNB count value of MeNB 1 becomes two, as a result.

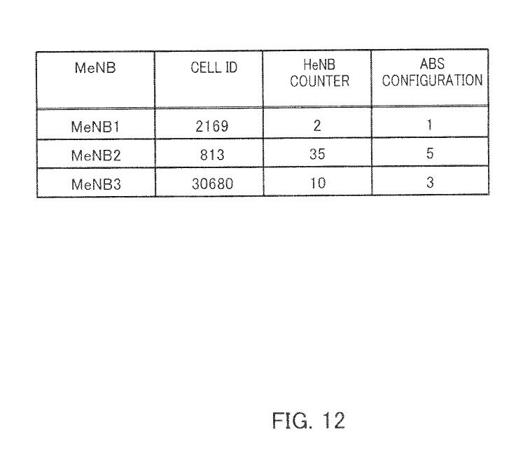

ABS configuration determining section 203 updates the ABS configuration of MeNB 300 in the ABS configuration table illustrated in FIG. 6, based on the HeNB count value of ST 502 (ST 503). In the example illustrated in FIG. 4, the ABS configuration is changed to 1 as the number of HeNBs of MeNB 1 is changed to two. As a result, the ABS management table illustrated in FIG. 5 is updated to the table illustrated in FIG. 12.

ABS configuration transmitting section 204 transmits the ABS configuration in ST 503 to MeNB300 (ST504).

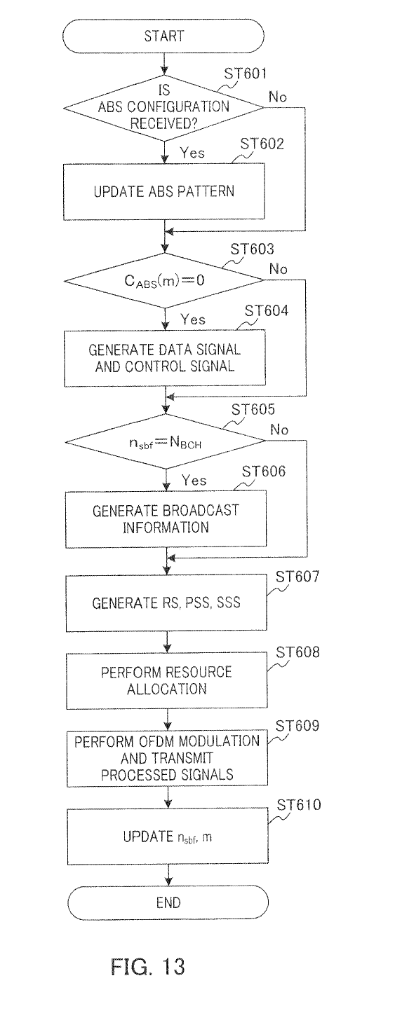

Next, the processing procedure of MeNB 300 illustrated in FIG. 9 will be described with reference to FIG. 13. In FIG. 13, ABS configuration receiving section 301 first determines whether or not an ABS configuration is indicated by OMC 200 (ST 601), and if there is an ABS configuration indicated by OMC 200, ABS configuration receiving section 301 updates ABS pattern C_{ABS}(m) based on the indicated ABS configuration (ST 602). When there is no ABS configuration indicated by OMC 200, the procedure proceeds to ST 603.

Scheduling section 302 determines whether or not a data signal and a control signal are transmittable in each subframe on the basis of ABS pattern C_{ABS}(m) (ST 603). When scheduling section 302 determines that the signals are transmittable (C_{ABS}(m)=0), the data payload, modulation scheme and resource allocation for the data signal are determined. At the same time, control information payload and resource allocation for the transmission control signal are determined (ST 604). When scheduling section 302 determines that the signals are not transmittable (C_{ABS}(m)=1), the procedure proceeds to ST605. It is determined whether or not a certain subframe (n_{sbf}) is a subframe (N_{BCH}) transmitting broadcast information (ST 605). When it is determined that the subframe (n_{sbf}) is a subframe (N_{BCH}) transmitting broadcast information, broadcast information generating section 304 generates broadcast information based on the ABS configuration and other information (such as a channel bandwidth and system frame number) indicated by a control section (not illustrated) (ST 606). When it is determined that the subframe (n_{sbf}) is not a subframe transmitting broadcast information, the procedure proceeds to ST607.

Reference signal generating section 303 generates a downlink reference signal (RS), a primary synchronization signal (PSS) and a secondary synchronization signal (SSS) (ST607).

Resource allocating section 307 allocates resources to time-frequency resources, the downlink reference signal (RS), the primary synchronization signal (PSS), the secondary synchronization signal (SSS), the broadcast information, the data signal, and the control signal (ST608).

OFDM modulation section 308 performs an inverse discrete Fourier transform on the signal allocated the resources, and adds a CP. In addition, radio section 309 transforms the OFDM modulated signal into a high frequency signal and transmits the high frequency signal to an MUE via antenna 310 (ST609).

Lastly, n_{sbf} and m are updated (ST610). When the subframe number and ABS pattern index of the next subframe are expressed by n′_{sbf} and m′, the following equations are established, respectively.

n′_{sbf}=mod(n_{sbf}+1, 20) (1)

m′=mod(m+1, 40) (2)

As described above, according to Embodiment 1, the OMC includes an ABS configuration table defined in such a way that the frequency of stopping downlink transmission is reduced as the number of HeNBs becomes smaller while the frequency of stopping downlink transmission is increased as the number of HeNBs becomes larger. The OMC manages the number of HeNBs in an MeNB area and determines the ABS configuration to he applied to the MeNB from the ABS configuration table in accordance with the number of HeNBs. Thus, it is possible to limit a decrease in the throughput of the whole network while avoiding interference to neighboring base stations.

### Embodiment 2

Embodiment 1 has been described with a case where the ABS pattern is changed in accordance with the number of HeNBs in the MeNB area. However, it is not true that all HeNBs in the MeNB area are affected by interference from the MeNB.

Let us discuss a case where HeNB 2 is installed at a cell edge of MeNB 1 in FIG. 4, for example. In this case, the interference from MeNB 1 to HUE 21 is small because of distance attenuation. As a result, a downlink desired signal from HeNB 2 becomes dominant in the received signal of HUE 21, so that favorable communication quality is secured even without increasing ABSs of MeNB 1. Stated differently, if MeNB 1 increases ABSs under this condition, radio resources arc wasted as a result.

Embodiment 2 will be described with a case where the ABS pattern is determined in accordance with the interfered power of an HeNB.

The system configuration according to Embodiment 2 of the present invention is identical with the configuration of Embodiment 1 illustrated in FIG. 4. Thus, the detailed description of the configuration will be omitted herein, and FIG. 4 will be used again as appropriate. As in the case of Embodiment 1, an assumption is made that HeNB 1 is in operation and HeNB 2 is not in operation (in power-off state) in Embodiment 2. In addition, the ABS management table and ABS configuration table of the OMC in Embodiment 2 are assumed to be the same as those illustrated in FIG. 5 and FIG. 6 of Embodiment 1.

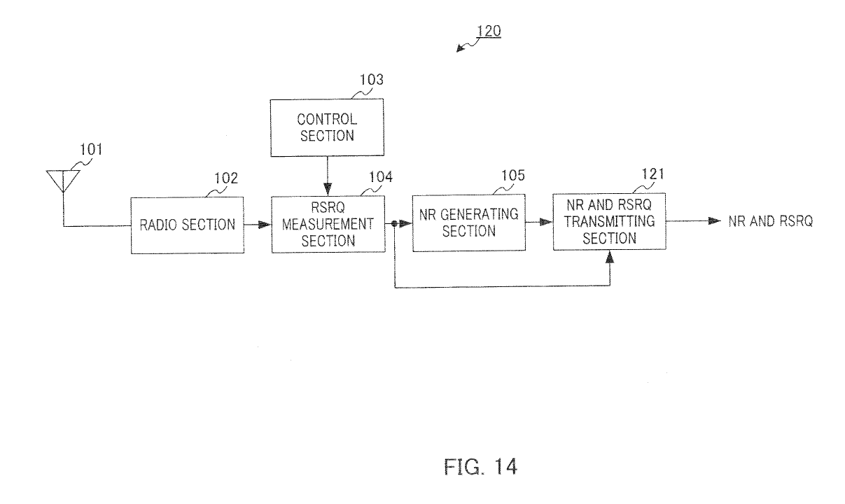

FIG. 14 is a block diagram illustrating a configuration of HeNB 120 according to Embodiment 2 of the present invention. FIG. 14 is different from FIG. 7 in that NR transmitting section 106 is replaced with NR and RSRQ transmitting section 121.

NR and RSRQ transmitting section 121 acquires a measured RSRQ from RSRQ measurement section 104 and also acquires NR information from NR generating section 105, and transmits the acquired RSRQ and NR information to the OMC. In the example illustrated in FIG. 4, an assumption is made that the interfering base station by which HeNB 2 is most affected is MeNB 1. In addition, the RSRQ in this case is assumed to be 3 (dBm). HeNB 2 transmits cell ID information 2169 of MeNB 1 and RSRQ=3 as NR to the OMC.

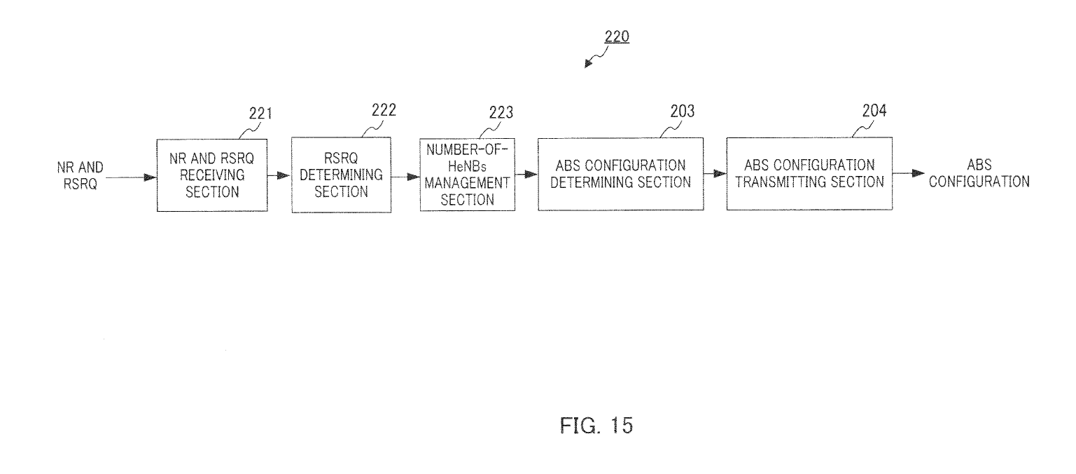

FIG. 15 is a block diagram illustrating a configuration of OMC 220 according to Embodiment 2 of the present invention. FIG. 15 is different from FIG. 8 in that NR receiving section 201 is replaced with NR and RSRQ receiving section 221, in that RSRQ determining section 222 is added, and in that number-of-HeNBs management section 202 is replaced with number-of-HeNBs management section 223.

NR and RSRQ receiving section 221 receives the NR and RSRQ transmitted from HeNB 120 and outputs the received NR and RSRQ to RSRQ determining section 222.

RSRQ determining section 222 compares the RSRQ outputted from NR and RSRQ receiving section 221 with a threshold (T_{RSRQ}) and outputs the result of comparison to number-of-HeNBs management section 223.

When the result of comparison outputted from RSRQ determining section 222 indicates that the RSRQ is greater than the threshold, number-of-HeNBs management section 223 determines that the HeNB is installed in the area of the base station indicated by the NR and updates the HeNB count value of the base station in the ABS management table illustrated in FIG. 5. When the result of comparison indicates that the RSRQ is not greater than the threshold, it is determined that the effect of interference from the MeNB on an HUE in the HeNB area is small.

When threshold T_{RSRQ}=1, for example, the RSRQ of HeNB 2 (=3) is greater than the threshold. Thus, the OMC increments the HeNB count value of MeNB 1 (cell ID=2169) in the ABS management table illustrated in FIG. 5. The HeNB count value of MeNB 1 becomes two, as a result.

It should he noted that, the configuration of the MeNB according to Embodiment 2 is identical with the configuration illustrated in FIG. 9 of Embodiment 1. Thus, the detailed description of the configuration will he omitted, hereinafter.

As described above, according to Embodiment 2, the number of HeNBs each having an RSRQ exceeding the threshold is counted among the HeNBs in the MeNB area, and the ABS configuration is determined accordingly. Thus, a decrease in the throughput of the whole network can be further limited.

### Embodiment 3

Embodiment 1 and Embodiment 2 have been described with an assumption that ABSs are set only in an MeNB. However, Embodiment 3 will be described with a case where ABSs are set in any one of or both of an MeNB and an HeNB in accordance with the HeNB count value.

The system configuration according to Embodiment 3 of the present invention is identical with the configuration of Embodiment 1 illustrated in FIG. 4. Thus, the detailed description of the configuration will be omitted herein, and FIG. 4 will be used again as appropriate. As in the case of Embodiment 1, an assumption is made that HeNB 1 is in operation and HeNB2 is not in operation (in power-off state) in Embodiment 3. The ABS management table and ABS configuration table of the OMC in Embodiment 3 are also assumed to be the same as those illustrated in FIG. 5 and FIG. 6 of Embodiment 1.

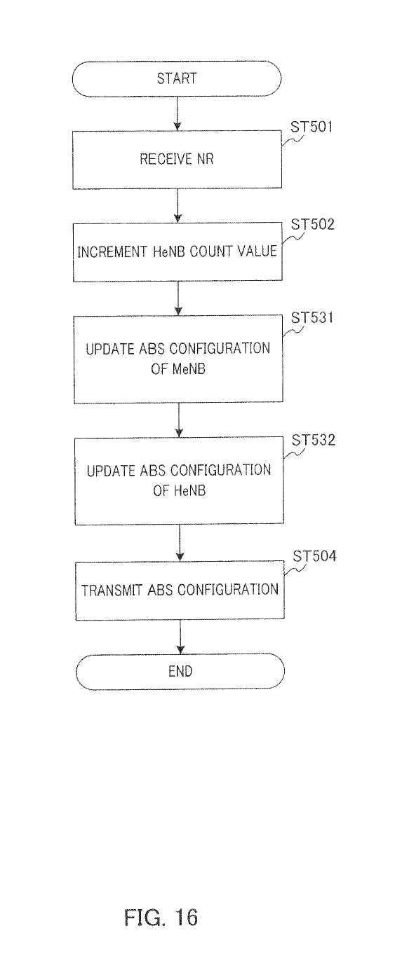

The configurations of the HeNB, OMC, and MeNB according to Embodiment 3 are identical with the configurations illustrated in FIGS. 7, 8, and 9 of Embodiment 1, respectively. Thus, the detailed description of the configurations will be omitted hereinafter. However, ABS configuration determining section 203 of the OMC according to Embodiment 3 has a different function. Accordingly, a description regarding the different function will be provided with reference to FIG. 16. Meanwhile, parts of FIG. 16 which are common with FIG. 11 are assigned the same reference numerals as those in FIG. 11, and any duplicate description will be omitted.

ABS configuration determining section 203 updates the ABS configuration of the MeNB and the ABS configurations of all the HeNBs in the MeNB area on the basis of the count value outputted from number-of-HeNBs management section 202.

Specifically, ABS configuration determining section 203 determines the ABS configuration corresponding to the HeNB count value of MeNB 1 with reference to the ABS configuration table in FIG. 6 (ST 531). Next, ABS configuration determining section 203 randomly selects a pattern for the ABS configurations of all the HeNBs in the MeNB 1 area from among patterns other than the ABS configuration of MeNB 1 (ST532).

In the example illustrated in FIG. 4, the HeNB count value of MeNB 1 becomes two, so that 1 is selected for the ABS configuration of MeNB 1. Next, a value except 1 is randomly selected for HeNB 1 and HeNB 2 from among ABS configurations 0 to 7.

As described above, according to Embodiment 3, applying an ABS configuration different from the ABS configuration applied to an MeNB to an HeNB makes it possible to reduce not only interference to an HUE but also interference to an MUE located near the HeNB, which in turn makes it possible to improve the throughput of the whole network.

It should be noted that, in Embodiment 3, when each HeNB reports an RSRQ to the OMC as illustrated in Embodiment 2, the ABS configuration for each HeNB may be selected in accordance with the RSRQ corresponding to the HeNB, instead of being randomly selected. In addition, when the OMC is aware of the installed location of each HeNB, the OMC may set ABS configurations in such a way that the ABS configurations do not overlap between neighboring base stations. In any selection method, it is important that the ABS configuration to be applied to each HeNB be selected in such a way that the ABS configuration is different from the ABS configuration of the MeNB.

Each of the above-noted embodiments has been described with an assumption that neighboring base station information is acquired when an HeNB is turned on. However, the neighboring base station information may be acquired, periodically such as daily.

In addition, the embodiments have been described with an assumption that the OMC indicates an ABS configuration to an MeNB. However, an ABS pattern consisting of a total of 40 bits may be used to directly indicate an ABS pattern to the MeNB. Likewise, although the embodiments have been described with an assumption that an MeNB and HeNB are configured to superimpose an ABS configuration on broadcast information, the MeNB and HeNB may be configured to superimpose an ABS pattern consisting of a total of 40 bits thereon.

The disclosure of the specification, the drawing, and the abstract of Japanese Patent Application No. 2011-027441, filed on Feb. 10, 2011, is incorporated herein by reference in its entirety.

### INDUSTRIAL APPLICABILITY

The server apparatus, small cell base station apparatus, and interference control method according to the present invention can be applied to mobile communication systems, for example.

### REFERENCE SIGNS LIST

101, 310 Antenna
102, 309 Radio section
103 Control section
104 RSRQ measurement section
105 NR generating section
106 NR transmitting section
201 NR receiving section
202, 223 Number-of-HeNBs management section
203 ABS configuration determining section
204 ABS configuration transmitting section
301 ABS configuration receiving section
302 Scheduling section
303 Reference signal generating section
304 Broadcast information generating section
305 Data signal generating section
306 Control signal generating section
307 Resource allocating section
308 OFDM modulation section
121 NR and RSRQ transmitting section
221 NR and RSRQ receiving section
222 RSRQ determining section

1. A server apparatus comprising:
a counting section configured to manage the number of small cell base station apparatuses each located in a cell of macro base station apparatus and forming a cell smaller than the cell of the macro base station apparatus;
a transmission and non-transmission pattern determining section configured to determine a first transmission and non-transmission pattern for the macro base station apparatus and a second transmission and non-transmission pattern for the small cell base station apparatuses in accordance with the number of small cell base station apparatuses located in the cell of the macro base station apparatus; and
a transmission section configured to transmit the determined first transmission and non-transmission pattern to the macro base station apparatus and to transmit the determined second transmission and non-transmission pattern to the small cell base station apparatuses.

2. The server apparatus according to claim 1, wherein
the transmission and non-transmission pattern determining section is configured to store a table including a plurality of transmission and non-transmission patterns defining that the frequency of non-transmission is reduced as the number of small cell base station apparatuses decreases, and that the frequency of non-transmission increases as the number of small cell base station apparatuses increases, and
the transmission and non-transmission pattern determining section is configured to obtain, from the table, a transmission and non-transmission pattern in accordance with the number of small cell base station apparatuses located in the cell of the macro base station apparatus.

3. The server apparatus according to claim 1, wherein the counting section is configured to count the small cell base station apparatus when signal strength information of the small cell base station apparatus is equal to or greater than a predetermined threshold.

4. The server apparatus according to claim 1, wherein the transmission and non-transmission pattern determining section is configured to determine the first transmission and non-transmission pattern and the second transmission and non-transmission pattern in such a way that the first transmission and non-transmission pattern and the second transmission and non-transmission pattern are different.

5. A small cell base station apparatus comprising:
a measurement section configured to acquire identification information of a neighboring base station apparatus and measures signal strength from the neighboring base station apparatus corresponding to the acquired identification information; and
a transmitting section configured to transmit the identification information and the signal strength to a server apparatus.

6. An interference control method comprising:
a counting step of managing the number of small cell base station apparatuses each located in a cell of a macro base station apparatus and forming a cell smaller than the cell of the macro base station apparatus;
a transmission and non-transmission pattern determining step of determining a first transmission and non-transmission pattern for the macro base station apparatus and a second transmission and non-transmission pattern for the small cell base station apparatuses in accordance with the number of small cell base station apparatuses located in the cell of the macro base station apparatus; and
a transmission step of transmitting the determined first transmission and non-transmission pattern to the macro base station apparatus and transmitting the determined second transmission and non-transmission pattern to the small cell base station apparatuses.
